(19) United States
(12) Patent Application Publication
(10) Pub. No.: US 2013/0034004 A1
(43) Pub. Date: Feb. 7, 2013

(54) REFERENCE TBTT ESTIMATION ALGORITHM FOR SMART POWER SAVING ON WLAN CLIENT

(71) Applicants: Chaitanya MANNEMALA, Santa Clara, CA (US); Guido Robert FREDERIKS, Aptos, CA (US); Sudheer KONDA, San Diego, CA (US); Gopal CHILLARIGA, Campbell, CA (US)

(72) Inventors: Chaitanya MANNEMALA, Santa Clara, CA (US); Guido Robert FREDERIKS, Aptos, CA (US); Sudheer KONDA, San Diego, CA (US); Gopal CHILLARIGA, Campbell, CA (US)

(73) Assignee: QUALCOMM ATHEROS, INC., San Jose, CA (US)

(21) Appl. No.: 13/563,192

(22) Filed: Jul. 31, 2012

Related U.S. Application Data
(60) Provisional application No. 61/514,285, filed on Aug. 2, 2011.

(51) Int. Cl. H04W 52/02; H04W 24/00

(52) U.S. Cl. 370/252; 370/311

(57) ABSTRACT

A WLAN client receives a plurality of beacons that include timestamp values that indicate when the beacons were sent by an access point (AP). The WLAN client calculates a beacon drift value for each of the plurality of received beacons in response to the timestamp values and known physical layer characteristics associated with the WLAN client. The WLAN client selects one of the calculated beacon drift values that represents a minimum beacon drift, and uses this selected beacon drift value (i.e., golden reference target beacon transmission time (RTBTT) estimate) to control the wakeup timing of the WLAN client. The golden RTBTT estimate is updated if a subsequently received beacon exhibits a shorter beacon drift value. If the wakeup wait period of the WLAN client exceeds a predetermined threshold for each of a plurality of received beacons, the golden RTBTT is recalculated to account for the associated increased beacon drift.

### RELATED APPLICATION

This application claims priority from U.S. Provisional Patent Application 61/514,285, entitled “Reference TBTT Estimation For Smart Power Saving On WLAN Client”, which was filed on Aug. 2, 2011, and is incorporated by reference herein.

### BACKGROUND

1. Field of the Disclosure

This disclosure relates generally to apparatus and methods for a wireless local area network (WLAN) client. More particularly, the disclosure relates to an apparatus and method for reference target beacon transmission time (RTBTT) estimation for smart power saving on a WLAN client.

2. Related Art

Wireless LAN technology (following the IEEE 802.11 specification) is one of the most commonly used connectivity technologies on smart phones and tablets today because this technology is economical and satisfies high bandwidth needs of applications. Because smart phones and tablets are battery powered, the power consumption of WLAN chipsets implemented by these devices is a critical design concern. As described below, the IEEE 802.11 specification provides protocol support for power savings on a WLAN client. However, this protocol support poses some challenges for WLAN chipset designers.

According to the IEEE 802.11 specification (the “protocol”), a wireless Access Point (AP) transmits beacons with an advertised periodicity known as a Beacon Interval (BI). Each of these beacons includes a timestamp field, which enables all of the associated clients of the AP to synchronize their local TSF (Timing Synchronization Function) timers with a TSF clock signal of the AP. Beacons also carry a Traffic Indication Map (TIM) that identifies buffered traffic stored at the AP. The protocol requires that an AP use time ‘zero’ as a first Target Beacon Transmission Time (TBTT), which is also referred to as a ‘Reference TBTT’. At each TBTT, the AP schedules a beacon frame as the next frame for transmission using medium access rules.

Although the AP schedules the transmission of a beacon at a specific target beacon transmission time (TBTT), the actual transmission of the beacon may be delayed, for example, by delays due to carrier sense multiple access (CSMA) procedures used to acquire the medium. In spite of the fact that the transmission of beacons may be ‘drifted’ on the medium (over air) due to delays resulting from CSMA procedures, the AP must strictly follow the TBTT timings mandated by the IEEE 802.11 specification.

FIG. 1 is a timing diagram illustrating the manner in which the transmission of a beacon may be drifted (delayed) from the associated target beacon transmission time. As illustrated by FIG. 1 target beacon transmission times TBTT_1, TBTT_2 and TBTT_3 are separated by the defined beacon interval. At time TBTT_1, the transmission medium is not busy, so the AP is able to transmit the scheduled beacon B1 without delay. However, at time TBTT_2, the transmission medium is busy. As a result, transmission of the scheduled beacon B2 is delayed (i.e., drifted) until after the medium is no longer busy. At TBTT_3, the transmission medium is not busy, so the AP is able to transmit the scheduled beacon B3 without delay.

Regardless of whether a beacon is drifted, WLAN clients are required to periodically wake up (in response to the beacon interval and the TBTT timing) to receive the beacons. Thus, each WLAN client requires beacon interval information and Reference TBTT information to follow the AP's schedule of beacon transmission (provided the TSF timer at the WLAN client is in synchronism with the TSF clock of the AP). The beacon received by the WLAN client includes a field that defines the beacon interval, whereby the WLAN client may identify the beacon interval. The WLAN client may blindly set the reference TBTT equal to zero, as long as the AP follows the IEEE 802.11 specification.

Unfortunately, many APs in current usage do not follow the reference TBTT timing for beacon transmission as mandated by the IEEE 802.11 specification. These APs may select a non-zero time as the reference TBTT timing, and periodically transmit beacons (with the defined beacon interval) with reference to that non-zero time. Hence, a WLAN client cannot reliably assume that the Reference TBTT is set equal to zero as mandated by the IEEE 802.11 specification. If a WLAN client assumes that the Reference TBTT is equal to zero, and the reference TBTT is in fact not equal to zero, the WLAN client may lose synchronization with the AP. That is, the WLAN client may not wake up at the proper times to detect the beacons transmitted by the AP.

Even if the AP follows the reference TBTT timing for beacon transmission as mandated by the IEEE 802.11 specification (i.e., the reference TBTT is equal to zero), the actual beacon transmission times heavily depend on the status of the transmission medium, as illustrated by FIG. 1. If the medium is heavily occupied (busy), the transmission of all beacons may be delayed (i.e., there may be drift in all beacons), undesirably resulting in increased power consumption within the WLAN clients. This increased power consumption results because the WLAN clients wake up with a timing specified by the reference TBTT and the beacon interval, and then must remain awake (i.e., powered up) until the corresponding delayed beacon is eventually received.

It would therefore be desirable to have an improved method and structure for controlling the wake up timing of WLAN clients in wireless networks that include APs that implement non-zero reference TBTT timings and/or exhibit significant beacon drift due to a heavily occupied transmission medium.

### SUMMARY OF THE DISCLOSURE

Accordingly, the present invention provides a method and apparatus for controlling the wakeup timing of a WLAN client in response to timestamp values included in the received beacon and known delays associated with the physical layer of the WLAN client. The wakeup timing of the WLAN client is adjusted in response to detecting a beacon that exhibits a minimum beacon delay. The wakeup timing of the WLAN can be automatically adjusted in response to determining that the drift (delay) of beacons has increased over a monitored time period.

One embodiment of the present invention includes a method that includes (1) receiving, with a WLAN client, a first beacon frame transmitted by an access point (AP), wherein the first beacon frame includes a first timestamp value that indicates when a timestamp field of the first beacon frame is transmitted; (2) subtracting a physical layer delay value from the first timestamp value to obtain a first reference target beacon transmission time (TBTT) value, wherein the physical layer delay value represents a known delay of the transmission of the first beacon frame through a physical layer (PHY); and (3) using the first reference TBTT value to determine a first time to wake up the WLAN client to receive a subsequent beacon frame transmitted by the AP.

The present method can further include (1) receiving, with the WLAN client, a second beacon frame transmitted by the AP, wherein the second beacon frame includes a second timestamp value that indicates when a timestamp field of the second beacon frame is transmitted; (2) subtracting the physical layer delay value from the second timestamp value to obtain a second reference TBTT value; (3) comparing the first reference TBBT value with the second TBTT value to determine whether the first reference TBTT value or the second reference TBTT value represents a shorter beacon delay; (4) setting a golden reference TBTT value to correspond with whichever one of the first reference TBTT value and the second reference TBTT value represents a shorter beacon delay; and (5) using the golden reference TBTT value to determine a second time to wake up the WLAN client to receive a subsequent beacon frame transmitted by the AP.

The present method can further include (1) determining, over a plurality of wake up periods, a plurality of wait periods, each existing between a time the WLAN client wakes up and a time the WLAN client receives a beacon frame transmitted by the AP; (2) determining a minimum one of the plurality of wait periods; (3) determining that the minimum one of the plurality of wait periods is greater than a predetermined threshold period; and (4) recalculating the golden reference TBTT value in response to determining that the minimum one of the plurality of wait periods is greater than the predetermined threshold period.

The present method can further include (1) determining, over a plurality of wake up periods, a number of times M that the WLAN client wakes up and does not detect a beacon frame; and (2) preventing the recalculation of the golden reference TBTT value in response to determining that the number of times M is greater than a predetermined number.

In accordance with another embodiment, the present invention includes a method comprising (1) receiving a plurality of beacon frames with a wireless LAN (WLAN) client; (2) determining a minimum beacon drift of the beacon frames in response to timestamp values included in the plurality of beacon frames and in response to physical layer characteristics of the WLAN client; and (3) waking up the WLAN client to receive beacon frames in response to the determined minimum beacon drift.

The present method can further include, for each waking up of the WLAN client, (1) determining a wait period that exists between a time that the WLAN client wakes up and a time that a beacon frame is received, and (2) determining that the wait period exceeds a minimum wait period during each of a plurality of waking ups of the WLAN client, and in response, recalculating the minimum beacon drift.

The present method can further include determining a number of times M during a plurality of waking ups of the WLAN client that the WLAN client fails to detect a beacon frame, and preventing the recalculating of the minimum beacon drift if M exceeds a predetermined threshold.

In accordance with another embodiment, the present invention includes a WLAN client that includes a beacon receive unit that receives a plurality of beacons transmitted from a wireless access point (AP), wherein each of the beacons includes a timestamp value that indicates when the beacon was transmitted from the wireless AP. The WLAN client also includes a computation unit coupled to receive the timestamp values from the beacon receive unit, wherein the computation unit estimates a delay associated with each of the plurality of beacons by subtracting a constant physical layer delay value from the timestamp values, thereby creating a plurality of reference target beacon transmission time (TBTT) samples.

In a particular embodiment, the computation unit includes means for selecting one of the reference TBTT samples exhibiting a minimum estimated delay, as well as means for storing this selected one of the reference TBTT samples as a golden reference TBTT estimate.

In accordance with another embodiment, the WLAN client includes a wakeup control unit coupled to the beacon receive unit and the storage unit, wherein the wakeup control unit wakes up the beacon receive unit to receive beacon signals with a timing specified by the golden reference TBTT estimate.

In accordance with another embodiment, the WLAN client includes means for determining, for a plurality of beacons, a plurality of corresponding wait periods, each existing from a time the beacon receive unit wakes up and a time the beacon receive unit receives a beacon.

In accordance with yet another embodiment, the WLAN client further includes: means for identifying a shortest one of the plurality of wait periods; means for determining whether the shortest one of the plurality of wait periods is greater than a predetermined wait period threshold value; and means for recalculating the golden reference TBTT estimate in response to determining the shortest one of the plurality of wait periods is greater than the predetermined wait period threshold value.

In accordance with yet another embodiment, the WLAN client further includes: means for determining, over the plurality of wake up periods, a number of times M that the beacon receive unit wakes up and does not detect a beacon; and means for preventing the recalculation of the golden reference TBTT value in response to determining that the number of times M is greater than a predetermined number.

The present invention will be more fully understood in view of the following description and drawings.

### BRIEF DESCRIPTION OF THE DRAWINGS

FIG. 1 is a timing diagram illustrating the manner in which the transmission of a beacon may be drifted (delayed) from an associated target beacon transmission time.

FIG. 2 is a timing diagram illustrating the timing of the transmission of a beacon frame from a wireless AP to a WLAN client.

FIG. 3 is a timing diagram illustrating the transmission of a plurality of beacons from an AP to a WLAN client, including the corresponding target beacon transmission times (TBTTs) of the AP and the awake periods of the WLAN client.

FIG. 4 is a timing diagram illustrating the transmission of a plurality of beacons from an AP to a WLAN client, including the corresponding TBTTs of the AP and the awake periods of the WLAN client, wherein the awake periods of the WLAN client are adjusted in response to a determined minimum beacon drift, in accordance with one embodiment of the present invention.

FIGS. 5A and 5B are timing diagrams that illustrate the manner in which a golden reference TBTT is selected in accordance with one embodiment of the present invention.

FIG. 6 is a timing diagram illustrating the recalculation of a golden RTBTT estimate over a period of four cycles in accordance with one embodiment of the present invention.

FIG. 7 is a block diagram that shows various elements of a WLAN client used to calculate and recalculate, if necessary, a golden RTBTT estimate used to wake up the WLAN client, in accordance with one embodiment of the present invention.

FIG. 8 is a flow diagram illustrating the manner that the various elements of the WLAN client of FIG. 7 operate in accordance with one embodiment of the present invention.

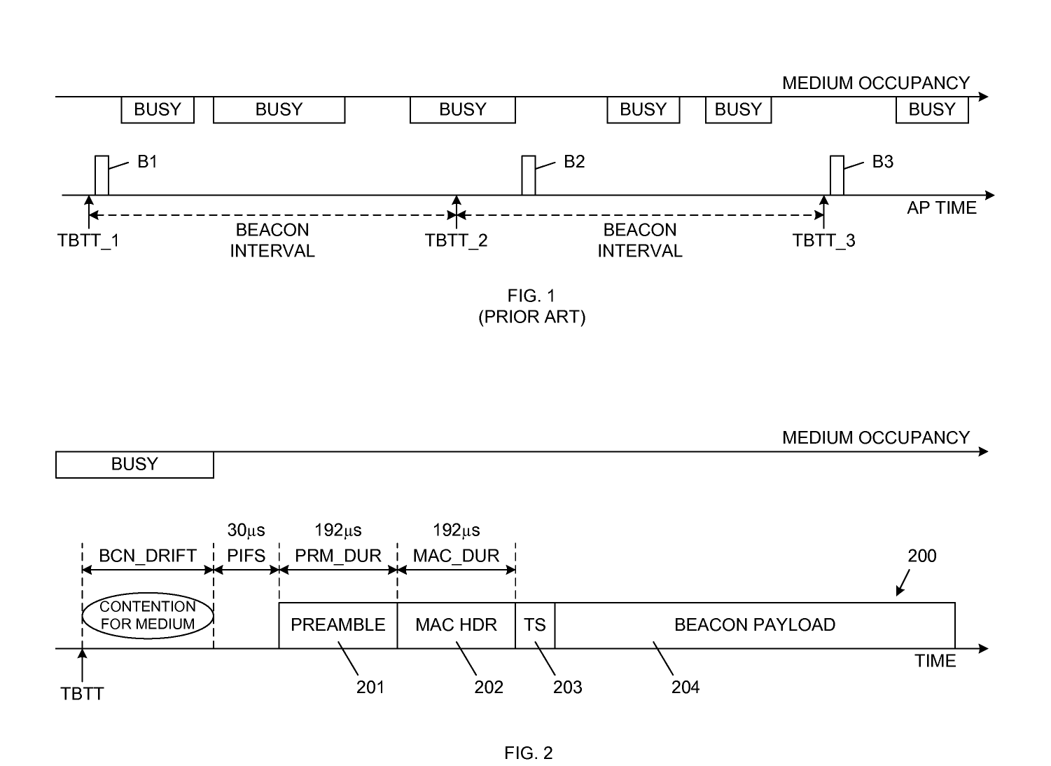

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the present disclosure.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

Various embodiments of a reference TBTT estimation system and method for smart power saving on a WLAN client are described herein below.

In accordance with one embodiment, the reference TBTT is estimated by a WLAN client based on heuristics of a plurality of beacons transmitted from an access point (AP). Because the first (reference) TBTT timing of the AP is not assumed by the WLAN client to be equal to zero, the reference TBTT estimation works well even with APs that do not follow the IEEE 802.11 specification protocol in regards to the TBTT timings. In accordance with another embodiment, the WLAN client estimates a minimum beacon drift, and automatically adjusts its wakeup timing in response to the estimated minimum beacon drift. In yet another embodiment, the WLAN client monitors the beacon drift over time, and upon determining that the beacon drift increases above a certain threshold over a predetermined time period, adjusts its wakeup timing to reflect the increased beacon drift. In another embodiment, the WLAN client monitors a number of detected beacon misses over the predetermined time period, and upon determining that a detected number of beacon misses over the predetermined time period exceeds a predetermined threshold value, prevents the wakeup timing of the WLAN client from being adjusted in response to an increased beacon drift.

FIG. 2 is a timing diagram illustrating the timing of the transmission of a beacon frame 200 from a wireless AP (not shown). Beacon frame 200 includes preamble 201, media access control (MAC) header 202, timestamp field 203 and beacon payload 204. Beacon frame 200 has an associated target beacon transmission time (TBTT) specified by the AP. However, as illustrated, the transmit medium is busy at time TBTT, thereby resulting in contention for the medium, such that there is a delay (i.e., beacon drift BCN_DRIFT) in the transmission of beacon frame 200. FIG. 2 also illustrates the point coordinator inter frame space (PIFS) time, which is introduced by the AP in accordance with the IEEE 802.11 specification.

According to the IEEE 802.11 specification, the timestamp field 203 in beacon frame 200 represents the Time Synchronization Function (TSF) clock at the AP when the first bit of the timestamp value TS stored in the timestamp field 203 reaches the physical (PHY) layer of the AP from the MAC interface of the AP, plus the transmitting delays of the AP through its local PHY from the MAC-PHY interface to its interface with the Wireless Medium (WM). Considering the PHY latencies from the MAC to the wireless medium WM to be negligible, the TBTT at the AP can be calculated by the following equation:

TBTT={TS}−{MAC_DUR}−{PRM_DUR}−{PIFS}−{BCN_DRIFT} Equation (1)

wherein {TS} represents the timestamp value stored in the timestamp field 203 of beacon frame 200, {MAC_DUR} represents the time required to transmit the MAC header 202 of beacon frame 200, {PRM_DUR} represents the time required to transmit the preamble 201 of beacon frame 200, {PIFS} represents the specified duration of the PIFS, and {BCN_DRIFT} represents the drift (delay) in transmitting the beacon frame 200 from TBTT due to medium (channel) access delays.

The WLAN client can obtain the timestamp value {TS} from the timestamp field 203 of the received beacon frame 200. The WLAN client can calculate {MAC_DUR} in response to a known length of the MAC header field 202 and the PHY rate at which the beacon frame 200 is transmitted. For example, MAC header field 202 may have a known length of 24 bytes and a PHY rate of 1 Mbps, resulting in a {MAC_DUR} value of 192 μs. In a similar manner, the WLAN client can calculate {PRM_DUR} and {PIFS} based on the known characteristics of the associated PHY. For example, the {PRM_DUR} value may be equal to 192 μs and the {PIFS} value may be equal to 30 μs. Thus, the only unknown value on the right hand side of Equation (1) is the {BCN_DRIFT} value. As described above, this {BCN_DRIFT} value dynamically varies based on the occupancy of the medium. However, in a clean (non-noisy) environment where there is no interference on the medium, the minimum {BCN_DRIFT} value will always tends toward zero (because over a long time period, there will be some beacon frames transmitted without delay). (accurate?) Hence, the TBTT value can easily be estimated to a high level of accuracy using the calculation defined by Equation (1) in a clean environment. If the AP is strictly following the IEEE 802.11 specification, TBTT will have an initial value of zero, and the TBTT timings calculated in a clean environment will closely match the TBTT timings mandated by the IEEE 802.11 specification. If the AP is not strictly following the IEEE 802.11 specification, TBTT will have a non-zero initial value, which can be accurately estimated in a clean environment using Equation (1). In this manner, the initial TBTT can be accurately estimated.

In a noisy environment, the {BCN_DRIFT} value plays an important role in power consumption within the WLAN client. It is difficult for the WLAN client to estimate the {BCN_DRIFT} value in a noisy environment. A conventional WLAN client therefore does not try to estimate the {BCN_DRIFT} value. Instead, the conventional WLAN client simply wakes up at each of the scheduled TBTTs. However, one embodiment of the present invention recognizes that if all of the beacon frames transmitted by the AP are delayed (drifted) by a minimum of X msec over the air, it is better for the WLAN client to wake up X msec after the scheduled TBTTs, because such wake up timing will advantageously reduce the power consumption of the WLAN client.

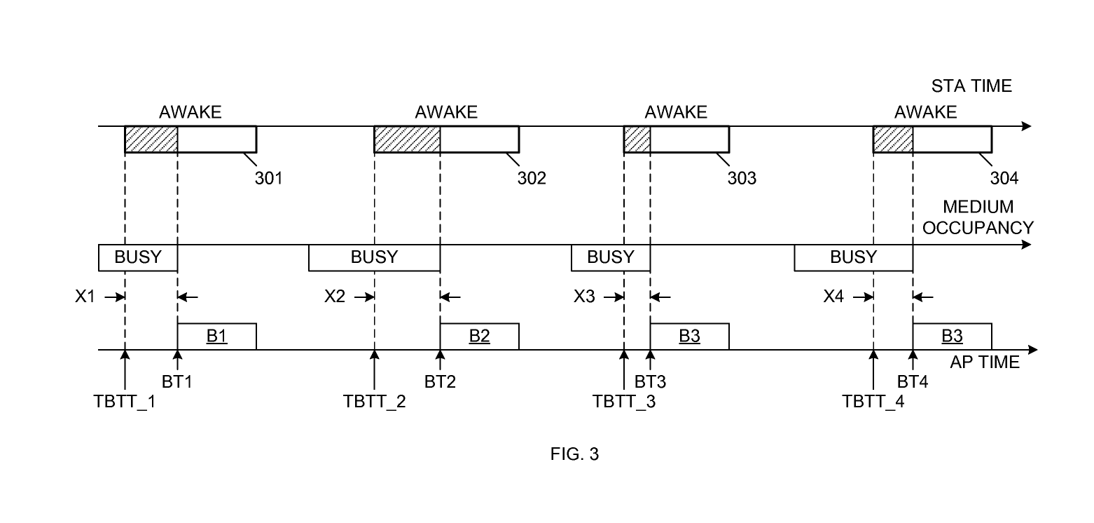

FIG. 3 is a timing diagram that illustrates a plurality of beacon transmission timings of an AP over the air with respect to the corresponding TBTT timings. As illustrated by FIG. 3, target beacon transmission times TBTT_1, TBTT_2, TBTT_3 and TBTT4 are designated within the AP. However, due to busy conditions on the transmission medium during these times, the AP does not actually transmit the corresponding beacon frames B1, B2, B3 and B4 until beacon transmission times BT1, BT2, BT3 and BT4, respectively. Thus, beacon frames B1, B2, B3 and B4 exhibit beacon drifts X1, X2, X3 and X4 respectively, wherein the beacon drift is defined as the time between the target beacon transmission time and the actual beacon transmission time. Because a conventional WLAN client (STA) does not know (and cannot predict) the value of the beacon drift for any particular beacon frame, a conventional WLAN client must wake up at the target beacon transmission times TBTT_1-TBTT_4. As a result, a conventional WLAN client must be awake during the awake periods 301-304 illustrated in FIG. 3. Because the WLAN client does not need to be awake until the actual beacon transmission times BT1-BT4, the shaded portions of awake periods 301-304 represent wasted power within the conventional WLAN client.

In the example illustrated by FIG. 3, the beacon drift is different during each of the beacon intervals, wherein X2>X1>X4>X3. Thus, the beacon drift X3 is the minimum beacon drift over a period of four beacon intervals. In accordance with one embodiment, of the present invention, the WLAN client collects heuristics of the beacon drift detected over a predetermined time period, and determines a minimum beacon drift seen by the WLAN client over the time period. Thus, in the example of FIG. 3, the WLAN client of the present invention would identify a minimum beacon drift of X3 msec over the four illustrated beacon intervals. In accordance with one embodiment, the WLAN client then adjusts its wake up timings in response to the determined minimum beacon drift. More specifically, the WLAN client of the present invention will delay its wake up timings by the determined minimum beacon drift (e.g., X3 msec).

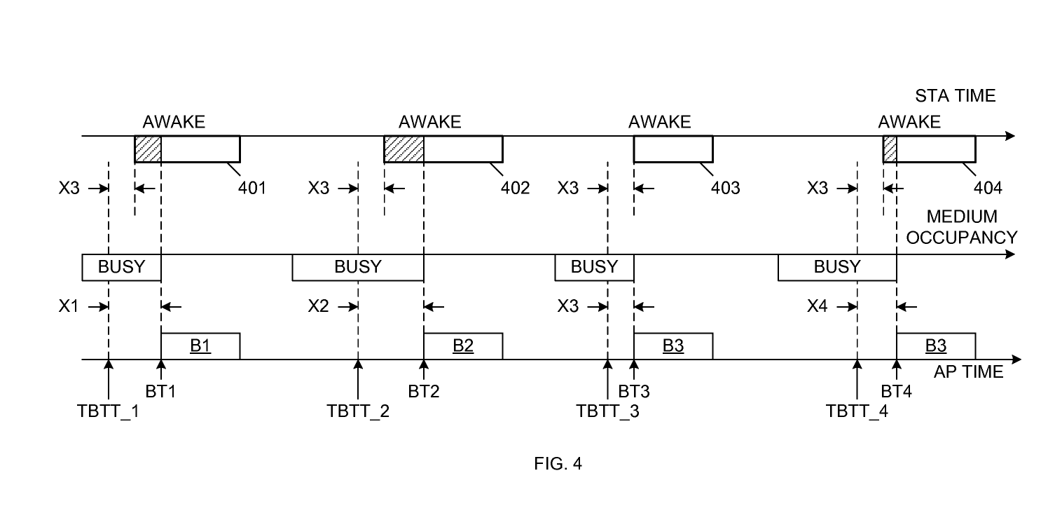

FIG. 4 is a timing diagram illustrating the TBTT timings and the corresponding actual beacon transmission timings of FIG. 3, with the wake up timings of the WLAN client adjusted by the determined minimum beacon drift X3, in accordance with one embodiment of the present invention. As illustrated by FIG. 4, the WLAN client wakes up X3 msec after each of the target beacon transmission timings TBTT_1-TBTT_4, such that the WLAN client is awake during awake periods 401-404. Under these conditions, the WLAN client is able to detect each of the transmitted beacon frames B1-B4. The shaded portions of the awake periods 401-404 represent wasted power within the WLAN client (i.e., time that the WLAN client is awake but has not yet received the corresponding beacon frame). Advantageously, the wasted power with the WLAN client of the present invention (FIG. 4) is significantly less than the wasted power within a conventional WLAN client (FIG. 3).

In accordance with one embodiment of the present invention, a method is provided to enable a WLAN client to estimate a reference TBTT (RTBTT) at which the WLAN client will wake up to detect a beacon frame. This RTBTT represents a target beacon transmission time (TBTT) of the AP, plus a minimum beacon drift detected by the WLAN client since association to the AP. Thus, the WLAN client does not need to estimate the TBTT of the AP, but rather, needs to estimate a value of TBTT+{BCN_DRIFT} that constitutes a minimum {BCN_DRIFT} seen by the WLAN client. The value of TBTT+{BCN_DRIFT}, which is referred to as an RTBTT sample, can be easily calculated in view of Equation (1) as follows:

RTBTT={TS}−{MAC_DUR}−{PRM_DUR}−{PIFS} Equation (2)

wherein all of the elements on the right side of Equation (2) are known, as described above in connection with Equation (1).

For every beacon frame that is received by the WLAN client, an RTBTT sample is computed using Equation (2). This process can be initiated immediately after the WLAN client completes the association process with the AP. In one embodiment, the WLAN client initially determines a “golden” RTBTT estimate by calculating (and storing) RTBTT samples for a first plurality of received beacon frames (e.g., 5 to 10 beacon frames), and then selecting the RTBTT sample having the smallest associated beacon drift as the golden RTBTT estimate. The golden RTBTT sample is used to estimate the next beacon transmission timing (i.e., is used to determine when to wake up the WLAN client to receive the next beacon). When a new beacon is received, the WLAN calculates a new RTBTT sample, and compares this new RTBTT sample with the golden RTBTT estimate. If the new RTBTT sample constitutes lesser {BCN_DRIFT} when compared to the golden RTBTT estimate, then the new RTBTT sample becomes the golden RTBTT estimate.

The procedure to determine whether the new RTBTT sample constitutes a minimum beacon drift over time will now be described in more detail. During every beacon interval, the WLAN client computes a new RTBTT sample. Using this new sample, the next TBTT is calculated (estimated).

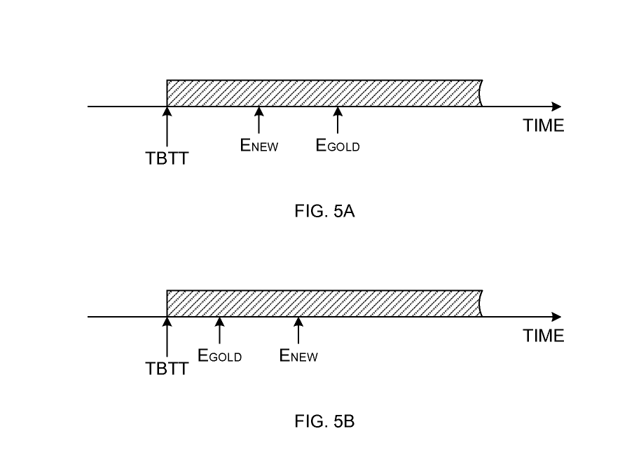

FIGS. 5A and 5B are timing diagrams illustrating the manner in which the next TBTT is calculated by the WLAN client in accordance with one embodiment of the present invention. FIGS. 5A and 5B illustrate the next target beacon transmission time TBTT of the AP (for reference), the estimated next TBTT calculated by the WLAN client in response to the new RTBTT sample (E_{NEW}), and the estimated next TBTT calculated by the WLAN client using the golden RTBTT estimate (E_{GOLD}). It is noted that the next TBTT calculations E_{NEW} and E_{GOLD} are associated with the same TBTT. As illustrated by FIGS. 5A and 5B, the next estimated TBTT (i.e., E_{NEW} and E_{GOLD}) will always exist in the shaded zone shown to the right of TBTT due to beacon drift.

In the example illustrated by FIG. 5A, the estimated next TBTT E_{NEW} falls to the left of the estimated next TBTT E_{GOLD} on the timeline, thereby indicating that the new RTBTT sample constitutes a lesser {BCN_DRIFT} value than the golden RTBTT estimate. In this case, the golden RTBTT estimate is replaced with the new RTBTT sample, wherein the new RTBTT sample is used to determine when to wake up the WLAN client to detect the next beacon.

In the example illustrated by FIG. 5B, the estimated next TBTT E_{NEW} falls to the right of the estimated next TBTT E_{GOLD} on the timeline, thereby indicating that the new RTBTT sample constitutes a greater {BCN_DRIFT} value than the golden RTBTT estimate. In this case, the new RTBTT sample is ignored, and the golden RTBTT estimate is used to determine when to wake up the WLAN client to detect the next beacon.

By following the above-described procedure to determine a wake up time for the WLAN client, power savings can be realized in the manner described above in connection with FIG. 4. However, over long periods of time, golden RTBTT estimate may come to represent a very small {BCN_DRIFT} value that approaches zero, because the golden RTBTT estimate can only be shifted left along the timeline (towards the TBTT) as illustrated by FIGS. 5A-5B. As a result, the above-described procedure, by itself, does not guarantee that the time between the WLAN client waking up and the time that the WLAN client receives a beacon frame (i.e., the beacon wait period) is minimized (i.e., does not guarantee that power consumption is minimized) over long operating time periods. This is because the golden RTBTT estimate corresponds with an RTBTT sample having a minimum beacon drift, regardless of when the RTBTT sample occurred. For instance, assume that the WLAN client received a beacon at some point in the past having almost zero beacon drift. The RTBTT sample associated with this beacon is selected as the golden RTBTT estimate, and the WLAN client will continue to use this golden RTBTT estimate even if all subsequent beacons exhibit significant beacon drift (e.g., due to a noisy environment). Under these conditions, the WLAN client will consistently wake up significantly earlier than necessary to detect the drifted beacon signals, such that power consumption is not minimized.

Thus, in accordance with one embodiment of the present invention, the golden RTBTT estimate is recalculated if the beacon drift increases over time. A method of recalculating the golden RTBTT estimate in response to detecting increased beacon drift over time will now be described in more detail.

In accordance with one embodiment, each time the WLAN client wakes up (at a time determined using the golden RTBTT estimate) to receive a beacon, the WLAN client starts a timer. When the WLAN client subsequently receives the beacon, the WLAN client stops the timer, thereby determining the time that the WLAN client is awake before receiving the beacon. This detected time period is hereinafter referred to as the “beacon wait period”. When the beacon drift suddenly increases due to high occupancy of the medium, the beacon wait period also increases. That is, an increased beacon wait period gives an indication of an increased beacon drift. In accordance with one embodiment, the beacon wait period is recorded in a circular buffer each time the WLAN client wakes up. The depth of the circular buffer (N) is chosen to be large enough that the contents of the circular buffer are representative of changes in the beacon drift over at least about 10 to 20 beacons.

In accordance with another embodiment, a predetermined value is written to the circular buffer if the WLAN client fails to detect a beacon during a wake up period. This predetermined value therefore identifies a “beacon miss” condition within the WLAN client, and is hereinafter referred to as a “beacon miss indicator value”.

Each time that a beacon wait period (or beacon miss indicator value) is recorded in the circular buffer (i.e., during each wake up of the WLAN client), the WLAN client determines the minimum beacon wait period stored in the circular buffer. If the minimum beacon wait period stored in the circular buffer is greater than a predetermined wait period threshold value, the beacon drift {BCN_DRIFT} has increased (by at least the predetermined wait period threshold value) over time (i.e., over the last N wake up intervals). The predetermined wait period threshold value can be set to 100 μsecs, by way of example. Of course, other predetermined wait period threshold values can be utilized while remaining within the spirit and scope of the invention as described herein (e.g., 10 μsecs to 1 ms).

In response to determining that the minimum beacon wait period stored in the circular buffer is greater than the predetermined wait period threshold value, the WLAN client recalculates the golden RTBTT estimate. In accordance with one embodiment, the WLAN client recalculates the golden RTBTT estimate in the same manner that the golden RTBTT estimate was originally calculated. That is, the new golden RTBTT estimate is calculated from scratch, by calculating (and storing) RTBTT samples for a first plurality of received beacon frames (e.g., 5 to 10 beacon frames), and then selecting the RTBTT sample having the smallest associated beacon drift as the golden RTBTT estimate. During the recalculation period, the WLAN client can use the previous golden RTBTT estimate, until the new golden RTBTT estimate is calculated. After the new golden RTBTT estimated is calculated, the contents of the circular buffer are erased, and the above-described process continues. Recalculating the golden RTBTT estimate in the above-described manner advantageously allows the golden RTBTT estimate, and therefore the wake up time of the WLAN client, to be shifted to the right (i.e., delayed) in response to increased beacon drift over time.

In accordance with another embodiment, each time that a beacon wait period (or beacon miss indicator value) is recorded in the circular buffer (i.e., during each wake up of the WLAN client), the WLAN client determines the number beacon miss indicator values stored in the circular buffer. The number of beacon miss indicator values stored in the circular buffer indicates that number of beacon misses that have occurred over the last N wake ups of the WLAN client. If the number of beacon miss indicator values stored in the circular buffer exceeds a predetermined beacon miss threshold value, then the WLAN client is prevented from recalculating the golden RTBTT estimate in the manner described above, because this recalculation may shift the golden RTBTT estimate to the right, thereby undesirably leading to more beacon misses. In one embodiment, the predetermined beacon miss threshold value is set equal to a value of about ______ to ______. However, it is understood that the predetermined beacon miss threshold value can have other values in other embodiments.

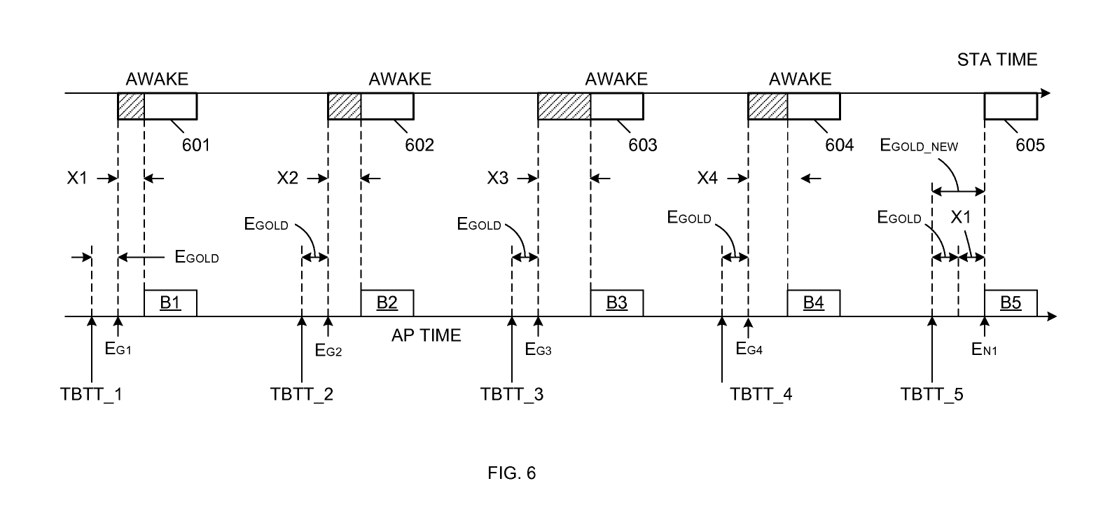

FIG. 6 is a timing diagram illustrating the recalculation of the golden RTBTT estimate over a period of four cycles. In the example illustrated by FIG. 6, the WLAN client determines that the golden RTBTT estimate must be recalculated prior to time TBTT_1. That is, the WLAN client determines that all of the beacon wait periods stored in the circular buffer exceed the predetermined wait period threshold value, and that the number of beacon miss indicator values stored in the circular buffer are fewer than the predetermined beacon miss threshold value. The WLAN client is controlled to wake up during time periods 601-604 using the previous golden RTBTT estimate E_{GOLD} to detect beacon signals B1-B4, as illustrated. As a result, the WLAN client wakes up at times E_{G1}, E_{G2}, E_{G3} and E_{G4}, which occur E_{GOLD} later than times TBTT_1, TBTT_2, TBTT_3 and TBTT_4, respectively. The WLAN client determines the beacon wait periods X1-X4 that the WLAN client is awake before detecting the beacons B1-B4, respectively. In the illustrated example, X3>X4>X2>X1, such that the WLAN client experiences a beacon wait period greater than or equal to X1 msec during each of the time periods 601-604. Although the example illustrated by FIG. 6 shows a recalculation period of 4 beacon periods, it is understood that other numbers of beacon periods can be used in other embodiments. For example, in a particular embodiment, the recalculation period includes from 5 to 10 beacon periods, which are enough to get a proper estimate.

Because the WLAN client wakes up at least X1 msec ahead of each actual beacon arrival time, there is significant needless power consumption within the WLAN client. Thus, the WLAN client recalculates a new golden RTBTT estimate E_{GOLD}_{_{—}}_{NEW}, which is shifted to the right by X1 msec when compared to E_{GOLD}. The recalculation is completed prior to time TBTT_5, such that the new golden RTBTT estimate E_{GOLD}_{_{—}}_{NEW} is used to wake up the WLAN client to detect the corresponding beacon B5. By following the new golden RTBTT estimate, the WLAN client wakes up at time E_{N1} after time TBTT_5, shown by window 605, which is shifted to the right by X1 msec with respect to the previous wakeups. As shown by FIG. 6, the wakeup window 605 happens to match exactly with the arrival of the corresponding beacon B5, thereby reducing power consumption of the WLAN client (because the WLAN client only wakes up to receive the beacon when the beacon actually arrives at the WLAN client).

In the manner described above, the WLAN client dynamically adjusts the golden RTBTT estimate in response to beacon drift. Because the estimation procedure does not rely on TBTT timings mandated by the IEEE 802.11 specification, this procedure works even with APs that do not follow the IEEE 802.11 specification on TBTT timings.

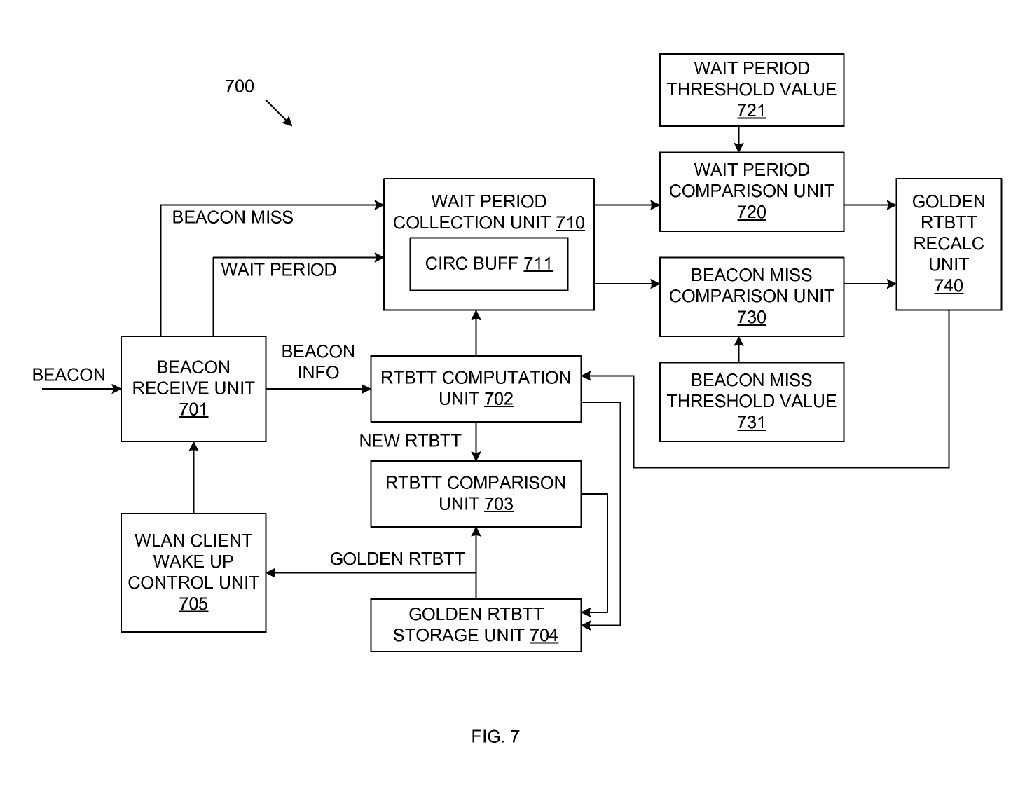

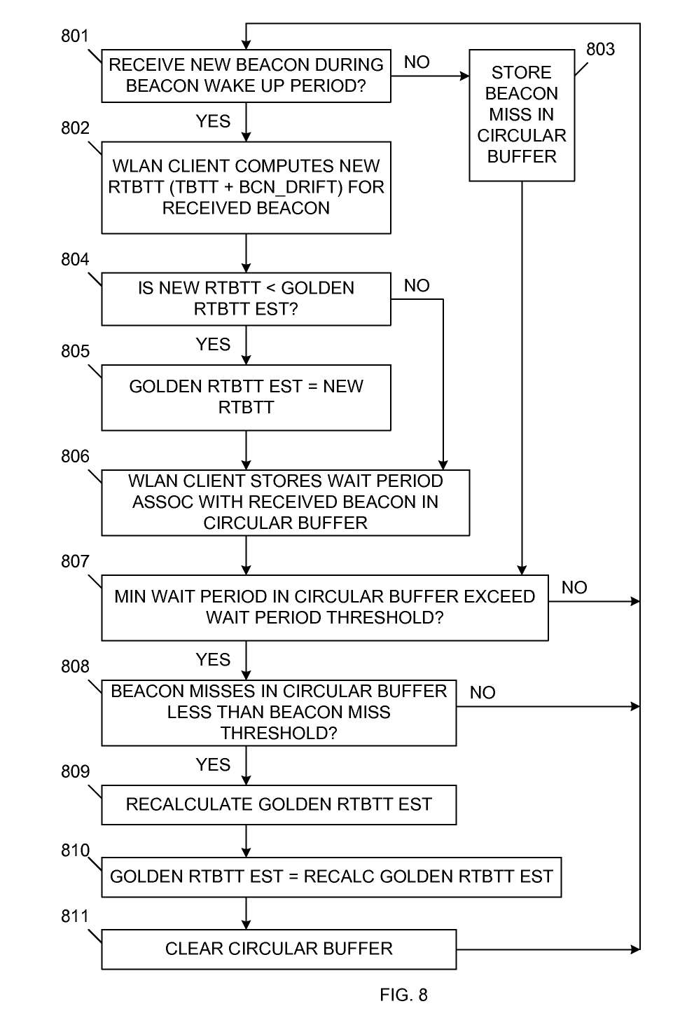

FIG. 7 is a block diagram that shows various elements of a WLAN client 700 used to implement the above-described methods in accordance with one embodiment of the present invention. WLAN client 700 includes beacon receive unit 701, RTBTT computation unit 702, RTBTT comparison unit 703, golden RTBTT storage unit 704, WLAN client wake up control unit 705, beacon wait period collection unit 710 (which includes N entry circular buffer 711), wait period threshold comparison unit 720, wait period threshold value storage 721, beacon miss comparison unit 730, beacon miss threshold value storage 731 and golden RTBTT recalculation unit 740. FIG. 8 is a flow diagram illustrating the manner that the various elements of WLAN client 700 operate in accordance with one embodiment of the present invention.

The golden RTBTT estimate is initially calculated in the manner described above, and is stored in golden RTBTT storage unit 704. More specifically, beacon receive unit 701 receives a plurality of beacon signals transmitted by the AP (not shown) over a plurality of beacon intervals. Beacon receive unit 701 transmits the beacon information to RTBTT computation unit 702, which generates (and stores) RTBTT samples for each of these received beacon signals in accordance with Equation (2). RTBTT computation unit 702 then selects the stored RTBTT sample having the smallest associated beacon drift as the golden RTBTT estimate, and writes this selected RTBTT sample to golden RTBTT storage unit 704 as the golden RTBTT estimate. WLAN client wakeup control unit 705 receives the golden RTBTT estimate from golden RTBTT storage unit 704, and in response, determines when to wake up beacon receive unit 701 in order to receive the next beacon signal transmitted by the AP. Beacon receive unit 701 wakes up in response to a control signal provided by WLAN client wakeup control unit 705, and attempts to detect a beacon.

If beacon receive unit 701 does not detect a beacon during the wake up period (Step 801, NO branch), then beacon receive unit 701 activates a beacon miss signal, which is received by wait period collection unit 710. In response, wait period collection unit 710 stores a beacon miss indicator value in circular buffer 711 that indicates a beacon miss was detected during the beacon period (Step 803).

If beacon receive unit 701 detects a beacon during the wake up period (Step 801, YES branch), beacon receive unit 701 transmits beacon information (e.g., the timestamp value stored in the timestamp field of the beacon) to RTBTT computation unit 702. In response, RTBTT computation unit 702 calculates a new RTBTT sample for the received beacon in the manner described above (Step 802). RTBTT computation unit 702 transmits the new RTBTT sample to RTBTT comparison unit 703.

RTBTT comparison unit 703 also receives the golden RTBTT estimate from golden RTBTT storage unit 704. In response, RTBTT comparison unit 703 compares the new RTBTT sample with the golden RTBTT estimate, and determines whether the new RTBTT sample represents a lesser beacon drift than the golden RTBTT estimate, in the manner described above (Step 804). If the new RTBTT sample represent a smaller beacon drift than the golden RTBTT estimate (Step 804, YES branch), then RTBTT comparison unit 703 overwrites the golden RTBTT estimate stored by golden RTBTT storage unit 704 (Step 805), and processing proceeds to Step 806. However, if the new RTBTT sample does not represent a smaller beacon drift than the golden RTBTT estimate (Step 804, NO branch), then the golden RTBTT estimate is not overwritten, and processing proceeds to Step 806.

Upon receiving a beacon (Step 801, YES branch), beacon receive unit 701 determines a beacon wait period that existed between the time the beacon receive unit 701 was woken up and the time the beacon was received. In one embodiment, beacon receive unit 701 includes a timer that starts when WLAN client wake up control unit 705 wakes up beacon receive unit 701, and stops when beacon receive unit 701 receives a beacon. Beacon receive unit 701 transmits a beacon wait period value that identifies the measured beacon wait period to wait period collection unit 710. In response, wait period collection unit 710 stores this beacon wait period value in circular buffer 711 (Step 806).

During each beacon interval, the wait period collection unit 710 identifies the minimum (smallest) beacon wait period value stored by circular buffer 711, and transmits this minimum beacon wait period value to wait period comparison unit 720. Wait period comparison unit 720 also receives the predetermined threshold period (i.e., a wait period threshold value) from wait period threshold value storage unit 721. Wait period comparison unit 720 compares the wait period threshold value with the minimum beacon wait period value from the circular buffer 711, and determines whether this minimum beacon wait period value is greater than the wait period threshold value (Step 807). Note that if the minimum beacon wait period value from the circular buffer 711 is greater than the wait period threshold value, then all of the beacon wait period values stored in the circular buffer 711 are necessarily greater than the wait period threshold value, thereby signifying a significant increase in the beacon drift over time. Wait period comparison unit 720 provides the comparison results to golden RTBTT recalculation unit 740. If the minimum beacon wait period value from the circular buffer 711 is less than the wait period threshold value (Step 807, NO branch), then golden RTBTT recalculation unit 740 is not activated, the golden RTBTT estimate stored by unit 704 is not changed, and processing returns to Step 801.

However, if each of the minimum beacon wait period value received from the circular buffer 711 is greater than the wait period threshold value (Step 807, YES branch), then processing proceeds to Step 808.

Although the wait period collection unit 710 calculates the minimum beacon wait period value stored in circular buffer 711 in the above-described embodiment, it is understood that in an alternate embodiment, wait period collection unit 710 could transmit each of the beacon wait period values stored by circular buffer 711 to wait period comparison unit 720. Wait period comparison unit 720 could then compare each of the beacon wait period values received from circular buffer 711 with the wait period threshold value to determine whether all of these beacon wait period values are greater than the wait period threshold value. In yet other embodiments, other methods for determining whether each of the beacon wait period values stored by the circular buffer 711 are greater than the wait period threshold value can be implemented.

During each beacon interval, the wait period collection unit 710 determines how many beacon miss indicator values are stored by the circular buffer 711, and in response, transmits a beacon miss count to beacon miss comparison unit 730, wherein the beacon miss count identifies the number of beacon miss indicator values stored by the circular buffer 711. Beacon miss comparison unit 730 also receives a beacon miss threshold value from beacon miss threshold value storage unit 731. Beacon miss comparison unit 730 compares the beacon miss count with the beacon miss threshold value, and determines whether the beacon miss count is less than the beacon miss threshold value (Step 808). Beacon miss comparison unit 730 provides the results of this comparison to golden RTBTT recalculation unit 740. If the beacon miss count is not less than the beacon miss threshold value (Step 808, NO branch), then golden RTBTT recalculation unit 740 is not activated, the golden RTBTT estimate stored by unit 704 is not changed, and processing returns to Step 801.

However, if the beacon miss count is less than the beacon miss threshold value (Step 808, YES branch), then golden RTBTT recalculation unit 740 is activated, whereby the golden RTBTT estimate is recalculated in the manner described above (Step 809). In one embodiment, the golden RTBTT recalculation unit 740 instructs RTBTT computation unit 702 to recalculate the golden RTBTT estimate (in the same manner that the RTBTT computation unit 702 originally calculated the golden RTBTT estimate over a plurality of beacon intervals). Note that the RTBTT samples stored in RTBTT computation unit 702 are cleared (erased) prior to recalculating the golden RTBTT estimate. As described above, RTBTT computation unit 702 may use the golden RTBTT estimate previously stored in golden RTBTT storage unit 704 during the recalculation of the golden RTBTT estimate.

Upon completing the recalculation of the golden RTBTT estimate, RTBTT computation unit 702 writes the new golden RTBTT estimate to golden RTBTT storage unit 704 (Step 810). At this time, RTBTT computation unit 702 also transmits a control signal to wait period collection unit 710, wherein wait period collection unit 710 clears (erases) the contents of circular buffer 711 in response to receiving this control signal (Step 811).

Although the present example describes the wait period comparison unit 720 and the beacon miss comparison unit 730 as being operated sequentially, it is understood that these units 720 and 730 can be operated in parallel in order to reduce processing time. Moreover, although the present example indicates that the golden RTBTT recalculation unit 740 processes the comparison results provided by comparison units 720 and 730, it is understood that in an alternate embodiment, golden RTBTT recalculation unit 740 can be eliminated, and the comparison results provided by comparison units 720 and 730 can be processed directly by RTBTT computation unit 702 to achieve the same results.

The various embodiments can be utilized for various APs that are available in the market for providing robustness and power economics. Also, good power consumption numbers for STAs as compared with APs can be obtained.

In the description above, exemplary methods for detecting beacon drift are described. Other methods can be utilized while remaining within the spirit and scope of the invention, but in the end also result in updating the reference TBTT.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. For example, {TS} can alternatively be derived from registering an internal running timer reference time, which would have some fixed time relationship to when a beacon is received. The formulas provided above with respect to the exemplary embodiments would still be applicable to embodiments in which {TS} is replaced by Tref internal+offset (where offset can be a positive or negative value). Thus, the present disclosure is not intended to be limited to the embodiments shown herein but is to be accorded the widest scope consistent with the principles and novel features disclosed herein.

What is claimed is:

1. A method comprising:
receiving, by a wireless LAN (WLAN) client, a first beacon frame transmitted by an access point (AP), wherein the first beacon frame includes a first timestamp value that indicates when a timestamp field of the first beacon frame is transmitted;
subtracting a physical layer delay value from the first timestamp value to obtain a first reference target beacon transmission time (TBTT) value, wherein the physical layer delay value represents a known delay of the transmission of the first beacon frame through a physical layer (PHY); and
using the first reference TBTT value to determine a first time to wake up the WLAN client to receive a subsequent beacon frame transmitted by the AP.

2. The method of claim 1, further comprising:
receiving, by the WLAN client, a second beacon frame transmitted by the AP, wherein the second beacon frame includes a second timestamp value that indicates when a timestamp field of the second beacon frame is transmitted;
subtracting the physical layer delay value from the second timestamp value to obtain a second reference TBTT value;
comparing the first reference TBBT value with the second TBTT value to determine whether the first reference TBTT value or the second reference TBTT value represents a shorter beacon delay;
setting a golden reference TBTT value to correspond with whichever one of the first reference TBTT value and the second reference TBTT value represents a shorter beacon delay; and
using the golden reference TBTT value to determine a second time to wake up the WLAN client to receive a subsequent beacon frame transmitted by the AP.

3. The method of claim 2, further comprising:
determining a wait period that exists between a time the WLAN client wakes up and a time the WLAN client receives a beacon frame transmitted by the AP;
determining that the wait period is greater than a predetermined threshold period; and
adjusting the golden reference TBTT value in response to determining that the wait period is greater than the predetermined threshold period.

4. The method of claim 2, further comprising:
determining, over a plurality of wake up periods, a plurality of wait periods, each existing between a time the WLAN client wakes up and a time the WLAN client receives a beacon frame transmitted by the AP;
determining a minimum one of the plurality of wait periods;
determining that the minimum one of the plurality of wait periods is greater than a predetermined threshold period; and
adjusting the golden reference TBTT value in response to determining that the minimum one of the plurality of wait periods is greater than the predetermined threshold period.

5. The method of claim 4, further comprising:
determining, over a plurality of wake up periods, a number of times M that the WLAN client wakes up and does not detect a beacon frame; and
preventing the adjusting of the golden reference TBTT value in response to determining that the number of times M is greater than a predetermined number.

6. The method of claim 1, wherein the physical layer delay value comprises:
a media access control (MAC) duration time required to transmit a MAC header of the first beacon frame;
a preamble duration time required to transmit a preamble of the first beacon frame; and
a point coordinator function inter frame space (PIFS) time required between frames on a wireless medium.

7. A method comprising:
receiving a plurality of beacon frames with a wireless LAN (WLAN) client;
determining a minimum beacon drift of the beacon frames in response to timestamp values included in the plurality of beacon frames and in response to physical layer characteristics of the WLAN client; and
waking up the WLAN client to receive beacon frames in response to the determined minimum beacon drift.

8. The method of claim 7, further comprising, for each waking up of the WLAN client, determining a wait period that exists between a time that the WLAN client wakes up and a time that a beacon frame is received.

9. The method of claim 8, further comprising determining that the wait period exceeds a minimum wait period during each of a plurality of waking ups of the WLAN client, and in response, recalculating the minimum beacon drift.

10. The method of claim 9, further comprising determining a number of times M during a plurality of waking ups of the WLAN client that the WLAN client fails to detect a beacon frame, and preventing the recalculating of the minimum beacon drift if M exceeds a predetermined threshold.

11. The method of claim 7, wherein the physical layer characteristics of the WLAN client includes:
a media access control (MAC) duration time required to transmit a MAC header of a beacon frame;
a preamble duration time required to transmit a preamble of a beacon frame; and
a point coordinator function inter frame space (PIFS) time required between frames on a wireless medium.

12. The method of claim 11, further comprising determining a minimum beacon drift of a beacon frame in response to subtracting the MAC duration time, the preamble duration time and the PIFS time from the timestamp value included in the beacon frame.

13. A wireless local area network (WLAN) client comprising:
a beacon receive unit that receives a plurality of beacons transmitted from a wireless access point (AP), wherein each of the beacons includes a timestamp value that indicates when the beacon was transmitted from the wireless AP; and
a computation unit coupled to receive the timestamp values from the beacon receive unit, wherein the computation unit estimates a delay associated with each of the plurality of beacons by subtracting a constant physical layer delay value from the timestamp values, thereby creating a plurality of reference target beacon transmission time (TBTT) samples.

14. The WLAN client of claim 13, wherein the constant physical layer delay value represents a known delay of the beacons through a physical layer.

15. The WLAN client of claim 13, wherein the computation unit includes means for selecting one of the reference TBTT samples exhibiting a minimum estimated delay.

16. The WLAN client of claim 15, further comprising a storage unit coupled to the computation unit, wherein the storage unit stores the one of the reference TBTT samples exhibiting a minimum estimated delay as a golden reference TBTT estimate.

17. The WLAN client of claim 16, further comprising a wakeup control unit coupled to the beacon receive unit and the storage unit, wherein the wakeup control unit wakes up the beacon receive unit to receive beacon signals with a timing specified by the golden reference TBTT estimate.

18. The WLAN client of claim 16, further comprising:
means for determining, for a plurality of beacons, a plurality of corresponding wait periods, each existing from a time the beacon receive unit wakes up and a time the beacon receive unit receives a beacon.

19. The WLAN client of claim 18, further comprising:
means for identifying a shortest one of the plurality of wait periods;
means for determining whether the shortest one of the plurality of wait periods is greater than a predetermined wait period threshold value; and
means for recalculating the golden reference TBTT estimate in response to determining the shortest one of the plurality of wait periods is greater than the predetermined wait period threshold value.

20. The WLAN client of claim 19, further comprising:
means for determining, over the plurality of wake up periods, a number of times M that the beacon receive unit wakes up and does not detect a beacon; and
means for preventing the recalculation of the golden reference TBTT value in response to determining that the number of times M is greater than a predetermined number.
